(19) United States
(12) Patent Application Publication
(10) Pub. No.: US 2015/0049263 A1
(43) Pub. Date: Feb. 19, 2015

(54) TOUCH DISPLAY DEVICE

(71) Applicants: Kuan-Yu Chu, Taichung City (TW); Chen-Fu Huang, Taichung City (TW); Chin-Pei Hwang, Taichung City (TW); Ming-Wu Chen, Nantou County (TW); Chun-Cheng Huang, Yunlin County (TW); Yu-Ching Wang, Taichung City (TW)

(72) Inventors: Kuan-Yu Chu, Taichung City (TW); Chen-Fu Huang, Taichung City (TW); Chin-Pei Hwang, Taichung City (TW); Ming-Wu Chen, Nantou County (TW); Chun-Cheng Huang, Yunlin County (TW); Yu-Ching Wang, Taichung City (TW)

(73) Assignee: WINTEK CORPORATION, Taichung City (TW)

(21) Appl. No.: 14/460,333

(22) Filed: Aug. 14, 2014

(30) Foreign Application Priority Data
Aug. 16, 2013 (TW) 102129555

(51) Int. Cl. G06F 3/041

(52) U.S. Cl. CPC G06F 3/041; G06F 2203/04102; G06F 2203/04107
USPC 349/12

(57) ABSTRACT

A touch display device including a touch panel, a protection layer, a conductive optical adhesive layer and a display panel is provided. The touch panel includes a substrate, pads, at least one grounding pad, a touch-sensing device, and at least one ESD protection line. The touch panel includes a pad area and an active area. The pads and the grounding pad are disposed on the substrate and located in the pad area. The touch-sensing device is disposed on the substrate and located in the active area. The ESD protection line is disposed on the substrate and located at a side of the active area. The protection layer including a first opening covers the touch panel and a portion of the pad area is exposed by the first opening. The conductive optical adhesive layer is disposed on the protection layer and electrically connected to the ESD protection circuit.

### CROSS-REFERENCE TO RELATED APPLICATION

This application claims the priority benefit of Taiwan application serial no. 102129555, filed on Aug. 16, 2013. The entirety of the above-mentioned patent application is hereby incorporated by reference herein and made a part of this specification.

### BACKGROUND OF THE INVENTION

1. Field of the Invention

The present invention generally relates to display device, and more particularly, to a touch display device.

2. Description of Related Art

In current information society, input devices of the various information technology (IT) products have been replaced from the conventional types, such as keyboards or mice, to touch-sensing panels. A touch display panel capable of performing both touch-sensing function and display function has become one of the most ubiquitous products on the market.

To improve the operation characteristic of a conventional touch display device, an electromagnetic shield film is adhered, using an optical adhesive, between the touch-sensing panel of the touch display device and the display device to increase the signal to noise ratio. The electromagnetic shield film is, for example, an indium tin oxide film. The presence of the electromagnetic shield film, however, impedes the reduction of the overall thickness of the touch display device; hence, the competitive edge of the touch display device is thereby reduced.

### SUMMARY OF THE INVENTION

Accordingly, the present invention is directed to a touch display device, wherein the thickness thereof is effectively reduced.

The touch display device of the present invention includes a touch-sensing panel, a protection layer, a conductive optical adhesive layer and a display panel. The touch-sensing panel includes a substrate, a plurality of touch pads, and at least a ground pad, a touch-sensing device, and at least an ESD (Electrostatic discharge) protection line. The touch-sensing panel includes a pad area and an active area. The pad area is configured at one side of the active area. The plurality of pads is disposed on the substrate at the pad area. The grounding pad is disposed on the substrate at the pad area. The touch-sensing device is disposed on the substrate and is at least at the active area, and the touch-sensing device includes a plurality of electrode patterns and a plurality of connecting lines, wherein each connecting line connects between the corresponding electrode patterns and the corresponding pads. The ESD protection line is disposed on the substrate and at least located at a side of the active area, wherein the ESD protection line is connected to the grounding pad. The protection pad covers the touch-sensing panel, and the protection layer includes a first opening, which exposes a part of the pad area. The conductive optical adhesive layer is disposed on the protection layer, and the conductive optical adhesive layer is electrically connected to the ESD protection line. The conductive optical adhesive layer is configured between the touch-sensing panel and the display panel.

In one exemplary embodiment of the present invention, the above protection layer includes a second opening that exposes a part of the ESD protection line, and the conductive optical adhesive layer is electrically connected to the ESD protection line through the second opening.

In one exemplary embodiment of the present invention, the above protection layer includes a second opening that exposes a part of the grounding pad, and the conductive optical adhesive layer is electrically connected to the grounding pad through the second opening.

In one exemplary embodiment of the present invention, the above conductive optical adhesive layer includes an optical adhesive and a plurality of conductive substances distributed in the optical adhesive. A material of the conductive substances includes, for example, poly ethylene dioxythiophene (PEDOT), polystyrene sulfonic acid (PSS), metal mesh, nano silver or an antistatic agent.

In one exemplary embodiment of the present invention, the above touch display device further includes a flexible circuit board. A part of the flexible circuit board is adhered to the pad area, and is electrically connected to the pads and the grounding pad.

In one exemplary embodiment of the present invention, the orthogonal projection of the above conductive optical adhesive layer on the substrate and the orthogonal projection of the above pad, exposed by the first opening, on the substrate do not overlap.

In one exemplary embodiment of the present invention, there may be two ESD protection lines respectively disposed at two opposite sides of the active area.

In one exemplary embodiment of the present invention, the above ESD protection line is U shape and located at a peripheral of the active area.

In one exemplary embodiment of the present invention, the material of the above touch-sensing device includes a transparent conductive material.

In one exemplary embodiment of the present invention, the material of the above ESD protection line includes metal or a transparent conductive material.

In one exemplary embodiment of the present invention, the first opening exposes a part of the at least one grounding pad at the pad area.

According to the above exemplary embodiments, in the touch display device of the present invention, a conductive optical adhesive layer having a conductive function is configured between the touch-sensing panel and the display panel to provide the shielding effect required by the touch display device. Accordingly, an additional electromagnetic shield film is not required for the touch display device and the overall thickness of the touch display device can be effectively reduced.

Based on the depiction above, the active device array and the testing method of the present invention can effectively inspect the defects in the circuits, which is conducive to advance the production yield.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top-view diagram of a touch display device according to an embodiment of the present invention.

FIG. 2 is a cross-section diagram of the touch display device depicted in FIG. 1 along the cutting line AA′.

FIG. 3 is a top view diagram showing a partial structure of the touch display device depicted in FIG. 1.

FIG. 4 is a top view diagram showing a partial structure of the touch display device depicted in FIG. 1.

FIG. 5 is a cross-section diagram of the touch display panel depicted in FIG. 1 along the cutting line BB′.

FIG. 6 is a top-view diagram of a touch display device according to another exemplary embodiment of the present invention.

FIG. 7 is a top-view diagram of a touch display device according to another exemplary embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

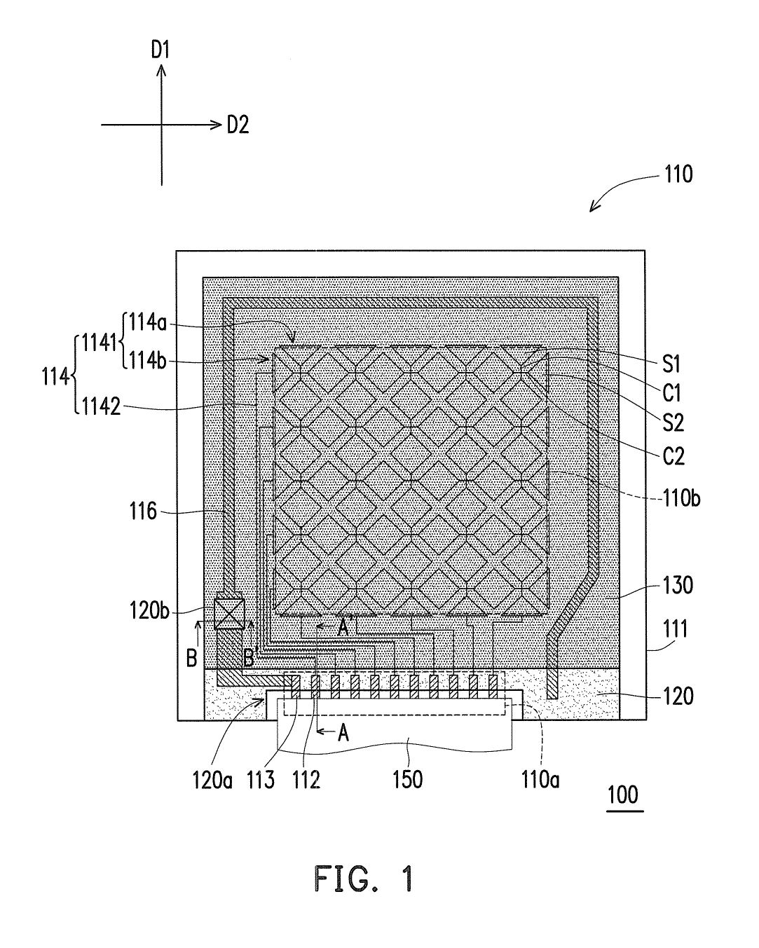

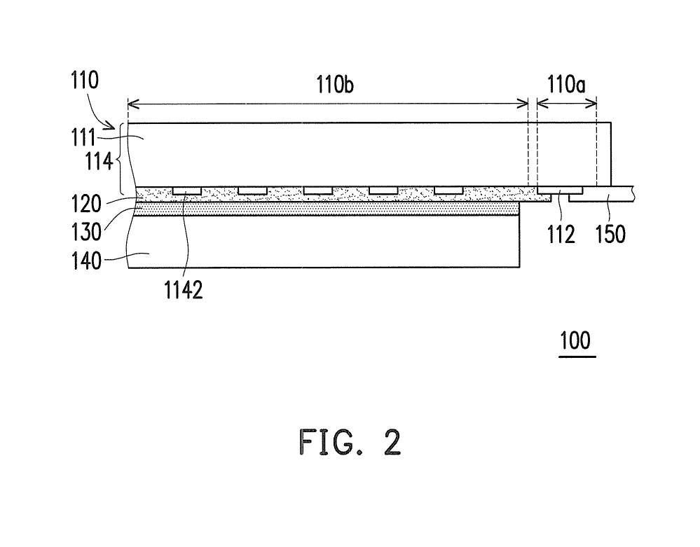

FIG. 1 is a top-view diagram of a touch display device according to an embodiment of the present invention. FIG. 2 is a cross-section diagram of the touch display device depicted in FIG. 1 along the cutting line AA′. Referring concurrently to FIG. 1 and FIG. 2, a touch display device 100 includes a touch-sensing panel 110, a protection layer 120, a conductive optical adhesive layer 130 and a display panel 140. The touch-sensing panel 110 includes a substrate 111, a plurality of pads 112, and least one grounding pad 113, a touch-sensing device 114 and an ESD protection line 116. Viewing from the top of the touch display device 100, the touch-sensing panel 110 includes a pad area 110a and an active area 110b and the pad area 110a is configured at one side of the active area 110b, wherein the boundary between pad area 110a and the active area 110b is denoted by a dash line in FIG. 1. The plurality of pads 112 is disposed on the substrate 111 in the pad area 110a. The grounding pad 113 is also disposed on the substrate 111 in the pad area 110a.

Further, as depicted in FIG. 1 and FIG. 2, the touch display device 100 further includes a flexible circuit board 150. A part of the flexible circuit board 150 is adhered to the pad area 110a, and is electrically connected to the pads 112 and the grounding pad 113. Another part of the flexible circuit board 150 is connected with, for example, a chip (not shown). Accordingly, the connecting lines 1142 and the ESD protection line 116 transmit signals to and from the flexible circuit board 150.

The touch-sensing device 114 is disposed on the substrate 111 and at least is disposed on the active area 110b. The touch-sensing device 114 include a plurality of electrode patterns 1141 and a plurality of connecting lines 1142, wherein each connecting line 1142 connects correspondingly between one corresponding electrode pattern 1141 and one pad 112. The ESD protection line 116 is disposed on the substrate 111 and at least located at a side of the active area 110b, wherein the ESD protection line 114 is connected to the grounding pad 113. In this exemplary embodiment, the touch-sensing panel 110 further includes a decoration layer (not shown), and the material of the decoration layer may include ink, a photoresist material or a ceramic material. The color of the decoration layer is, for example, black, white other appropriate frame colors. The declaration layer may be disposed on the substrate 111 or on another carrier (not shown), and is at least disposed at a portion of the periphery of the active area 110b to conceal the connecting lines 1142, the ESD protection line 116 and other peripheral devices of the touch-sensing panel 110.

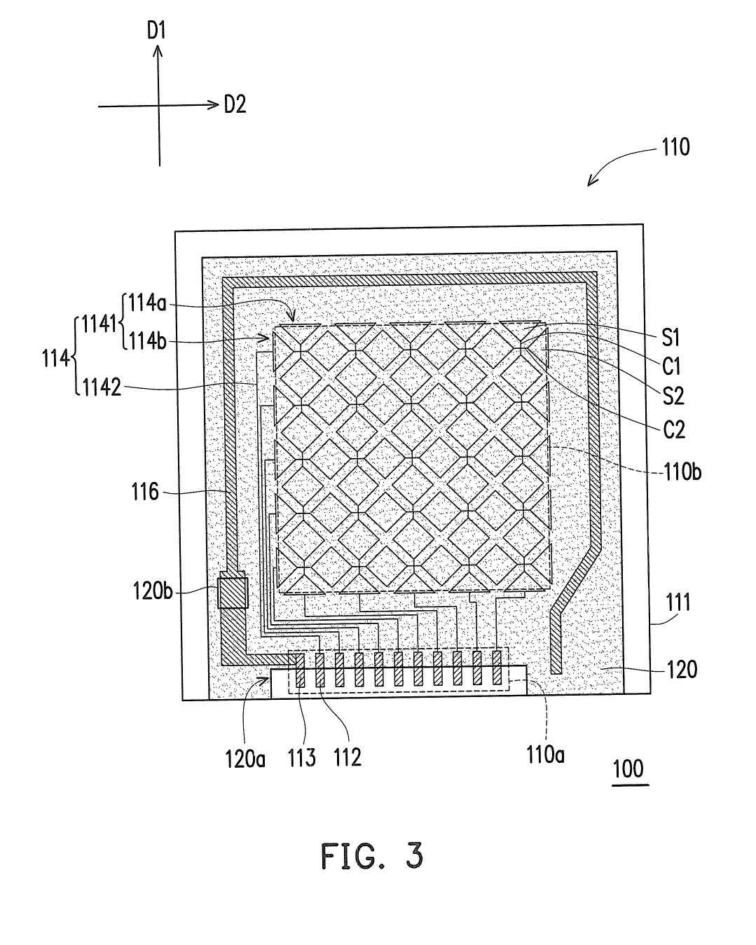

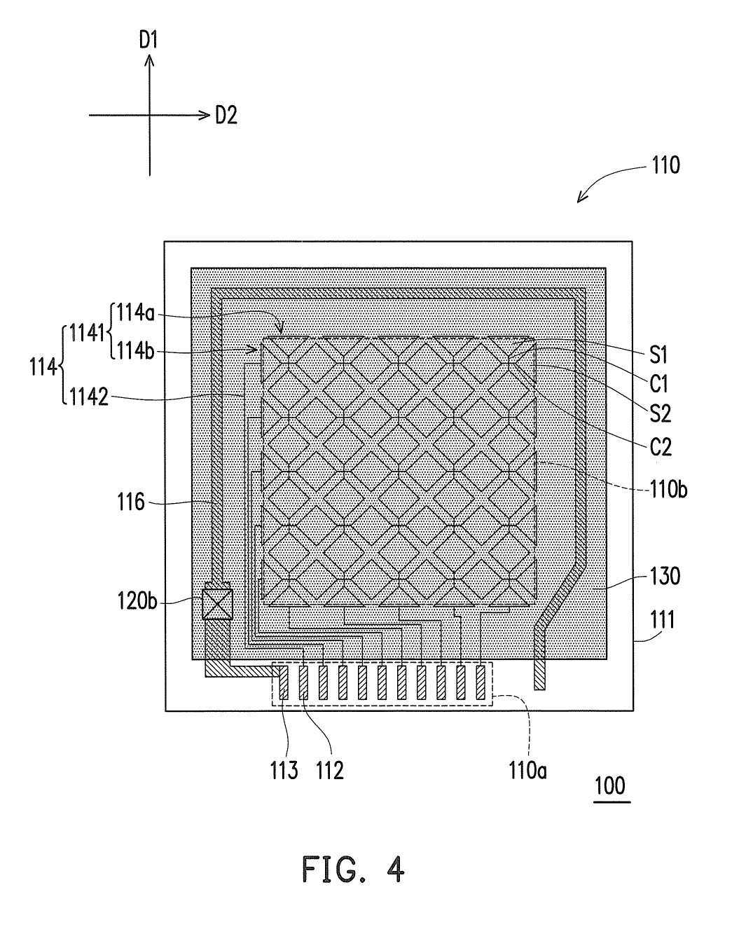

FIG. 3 is a top view diagram depicting the relationship of a part of the components in the touch display device in FIG. 1. FIG. 4 is a top view diagram depicting the relationship of a part of the components in the touch display device in FIG. 1. In order to clearly illustrate the dispositions and the profiles of the film layers of a part of the components in the touch display device 100, FIG. 3 only depicts the touch-sensing panel 110 and the protection layer 120 of the touch display device 100, while FIG. 4 only depicts the touch-sensing panel 110 and the conductive optical adhesive layer 130 of the touch display device 100. Referring to FIG. 3, the protection layer 120 covers the touch-sensing panel 110 to protect the components on the touch-sensing panel 110. The protection layer 120 has a first opening 120a, and the first opening 120a exposes a portion of the pads 110a so that a part of each pad 112 and a part of the grounding pad 113 are configured outside the coverage of the protection layer 120.

Referring to FIG. 1, FIG. 2 and FIG. 4 concurrently, as depicted in FIG. 4, the conductive optical adhesive layer 130 is configured on and within the coverage of the substrate 111. The conductive optical adhesive layer 130 is configured between the touch-sensing panel 110 and the display panel 140 to adhere the touch-sensing panel 110 to the display panel 140. Further, the conductive optical adhesive layer 130 is disposed on the protection layer 120 and is electrically connected to the ESD protection line 116. In this exemplary embodiment, the conductive optical adhesive layer 130 configured between the touch-sensing panel 110 and the display panel 140 includes a conductive function which can provide a shielding effect required by the touch display device 100. For example, the signal interference generated by the display panel 140 is lowered to obviate the touch display device 100 being affected by the signal interference. Moreover, according to this designing approach, having an electromagnetic shielding thin film in a touch display device 100 becomes unwarranted. Hence, the thickness of a touch display device 100 is effectively reduced.

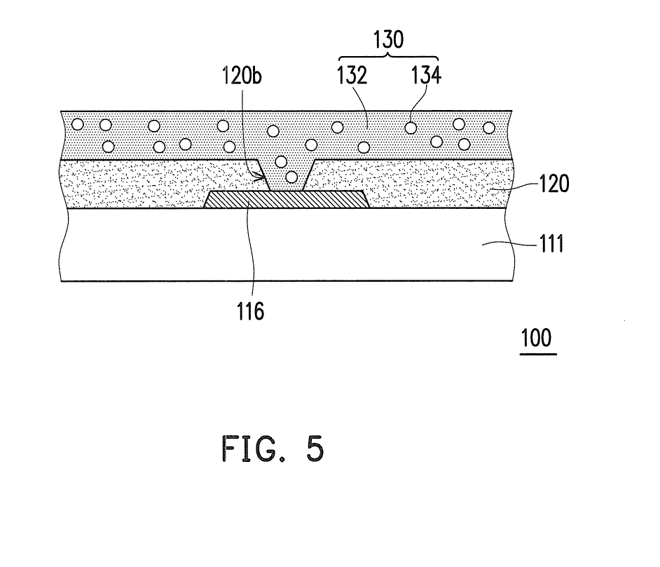

FIG. 5 is a cross-section diagram of the touch display panel depicted in FIG. 1 along the cutting line BB′. Referring to FIG. 1 and FIG. 5 concurrently, in this exemplary embodiment, the protection layer 120 has a second opening 120b, such as a contact opening. The second opening 120b exposes a part of the ESD protection line 116, and a portion of the conductive adhesive layer 130 fills the second opening 120b and is electrically connected to the ESD protection line 116 through the part of the ESD protection line 116 in the second opening 120b. Although the disclosure herein refers to a protection layer 120 having a second opening 1201) as the illustrated embodiments, it is to be understood that the number of the second openings may vary and modify according the design requirements. Referring to FIG. 4, only the touch-sensing panel 110 and the conductive optical adhesive layer 130 of the touch display device 110 are depicted. However, to more clearly illustrate the position of the second opening 120b of the protection layer 120, the second opening 120b and the portion of the conductive optical adhesive layer 130 filling the seconding opening 120b are illustrated in FIG. 4.

In this exemplary embodiment, the conductive optical adhesive layer 130 is in contact with the ESD protection line 116 and is connected to the flexible circuit board 150 through the ESD protection line 116. Therefore, it is not necessary for the flexible circuit board 150 to be directly connected to the conductive optical adhesive layer 130, and the connecting process of the flexible circuit board 150 is facilitated. Referring to FIG. 1, the orthogonal projection of the conductive optical adhesive layer 130 on the substrate 111 and the orthogonal projections of the pads 112, exposed by the first opening 120a, on the substrate 111 do not overlapped. Accordingly, a short, resulted from the conductive optical adhesive layer 130 being in contact with the pads 112 that are exposed in the pad area 110a, is prevented.

In this exemplary embodiment, the conductive optical adhesive layer 130 includes optical adhesive 132 and a plurality of conductive substances 134 distributed in the optical adhesive 132. The material of the conductive substances 134 may include poly ethylene dioxythiophene (PEDOT), polystyrene sulfonic acid (PSS), metal mesh, nano silver or an antistatic agent. During the fabrication of the conductive optical adhesive layer 130, a mechanical stirring method may be applied to uniformly distribute the conductive substances 134 in the optical adhesive 132 to render the conductive optical layer 130 with an improved uniform conductivity. Alternatively, a multiple-mixing method may be applied to mix the optical adhesive 132 and the conductive substances 134 to achieve the improved uniform conductivity.

Referring to FIG. 1, the ESD protection line 116 is, for example, U shape, and the ESD protection line 116 is located at a peripheral of the active area 110b. It is understood that the present invention is not limited thereto, and the ESD protection line 116 of the invention may have other configurations. For example, there may be two ESD protection lines 116 respectively disposed at two opposite sides of the active area 110b. Alternatively, the ESD protection line 116 may only be disposed at one side of the active area 110b, and the material of the ESD protection line 116 includes metal or a transparent conductive material.

Referring to FIG. 1, in this exemplary embodiment, the electrode patterns 1141 of the touch-sensing device 114 are constituted by a plurality of first electrode series 114a and a plurality of second electrode series 114b. As illustrated in FIG. 1, each first electrode series 114a extends along a first direction D1, and each second electrode series 114b extends along a second direction D2. In this exemplary embodiment, the first direction D1 is perpendicular to the second direction D2; however, it should be understood that the present invention may be practiced with the first direction D1 and the second direction D2 being obliquely intersected. Each of the first electrode series 114a is electrically connected to the corresponding pad 112 through the corresponding connecting line 1142 and each of the second electrode series 114b is electrically connected to the corresponding pad through the corresponding connecting line 1142.

In this exemplary embodiment, each first electrode series 114a may include a plurality of electrode parts S1 and a plurality of connecting parts C1, and the connecting parts C1 connect the plurality of electrode parts S1 along the first direction D1. Further each second electrode series 114b may include a plurality of electrode parts S2 and a plurality of connecting parts C2, and the connecting parts C2 connect the plurality of electrode parts S2 along the second direction D2. Since the connecting parts C1 and the connecting parts C2 intersect with each other, in order maintain electrical independency, an isolation structure (not shown) may be disposed between the connecting parts C1 and the connecting parts C2. Alternatively, the first electrode series 114a and the second electrode series 114b may be disposed at two opposite sides of an isolation structure (not shown). Further, when the touch-sensing device 114 in this exemplary embodiment is a single film layer, the electrode patterns 1411 in the touch-sensing device 114 are mutually independent and non-intersecting electrode patterns.

In this exemplary embodiment, the materials of the electrode parts S1 of the first electrode series 114a and the electrode parts S2 of the second electrode series 114b may include a transparent conductive material, such as indium tin oxide (ITO) or indium zinc oxide (IZO), or a metal mesh. Moreover, the connecting parts C1 and the connecting parts C2 may be fabricated with the above conductive materials. However, the present invention is not limited thereto. For example, one of the connecting parts C1 and the connecting parts C2 may be fabricated with a metal material, while the other of the connecting parts C1 and the connecting parts C2 may be fabricated with a transparent conductive material. Further, the materials of the connecting lines 1142 and the ESD protection line 116 may be metal or a transparent conductive material or a combination of the above conductive materials.

As shown in FIG. 2, the touch-sensing device 114 is fabricated on the substrate 111. The substrate 111 is a glass plate or other rigid substrates. The one glass solution (OGS) fabrication method may be applied to fabricate the touch display device 100 of the current exemplary embodiment, wherein the substrate may directly serve as the cover lens of the touch display device 100

In the above exemplary embodiments, the conductive adhesive layer 130 is electrically connected to the ESD protection line 116 through the second opening 120b, and the ESD protection 116 is further electrically connected to the ground pad 113. Further, the conductive optical adhesive layer 130 is configured completely outside the pad area 110a. However, in other exemplary embodiments, the conductive optical adhesive layer 130 may be connected to a ground potential through another configuration. Moreover, as long as the conductive optical adhesive layer 130 is precluded from contacting the pads 112 and causing a short, the conductive optical adhesive layer 130 may be configured inside the pad area 110a, and examples of which will now be made in details in the following disclosure.

Whenever possible, the reference numbers that are used in the drawings and the description in the previously disclosed embodiments will be used to refer to the same or like parts in the following exemplary embodiments. Further, similar technical contents, which can be referred to the previous exemplary embodiments, are omitted and are not reiterated in the description of the following exemplary embodiments.

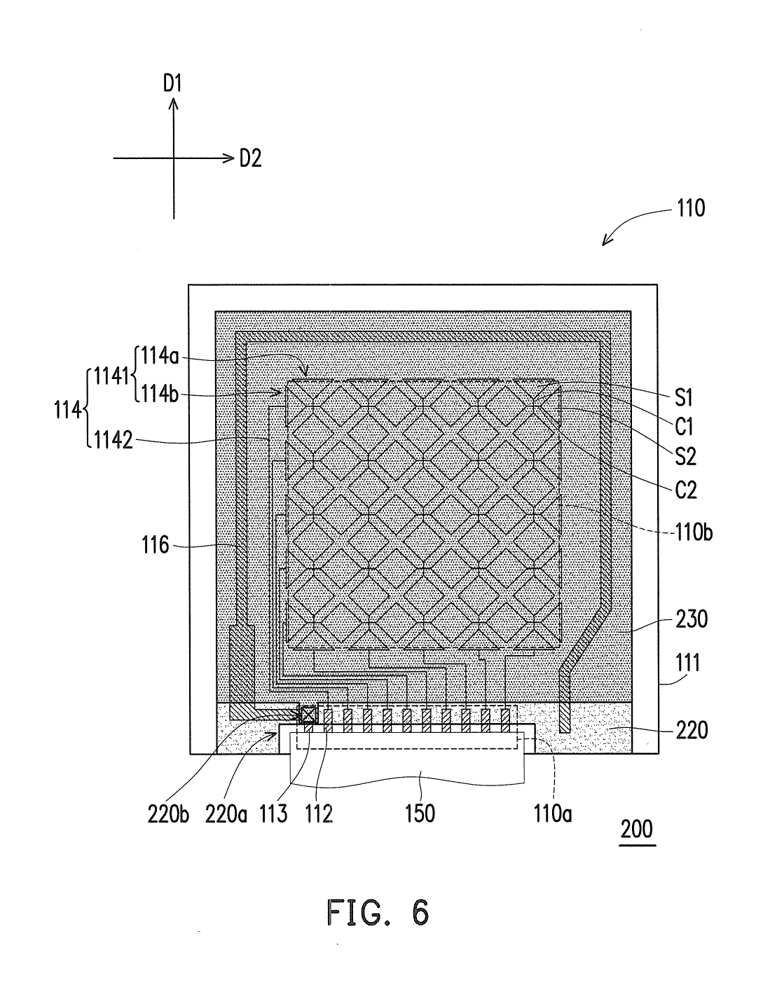

FIG. 6 is a top-view diagram of a touch display device according to another exemplary embodiment of the present invention. As shown in FIG. 6, a protection layer 220 of a touch display device 200 includes a second opening 220b, and the second opening 220b exposes a part of a ground pad 113, wherein the conductive optical adhesive layer 230 is electrically connected to the ground pad 113 through the second opening 220a. In this exemplary embodiment, the second opening 220b is configured at the pad area 110a, and a part of the conductive optical adhesive layer 230 is configured in the pad area 110a and is directly electrically connected to the ground pad 113 through the second opening 220a.

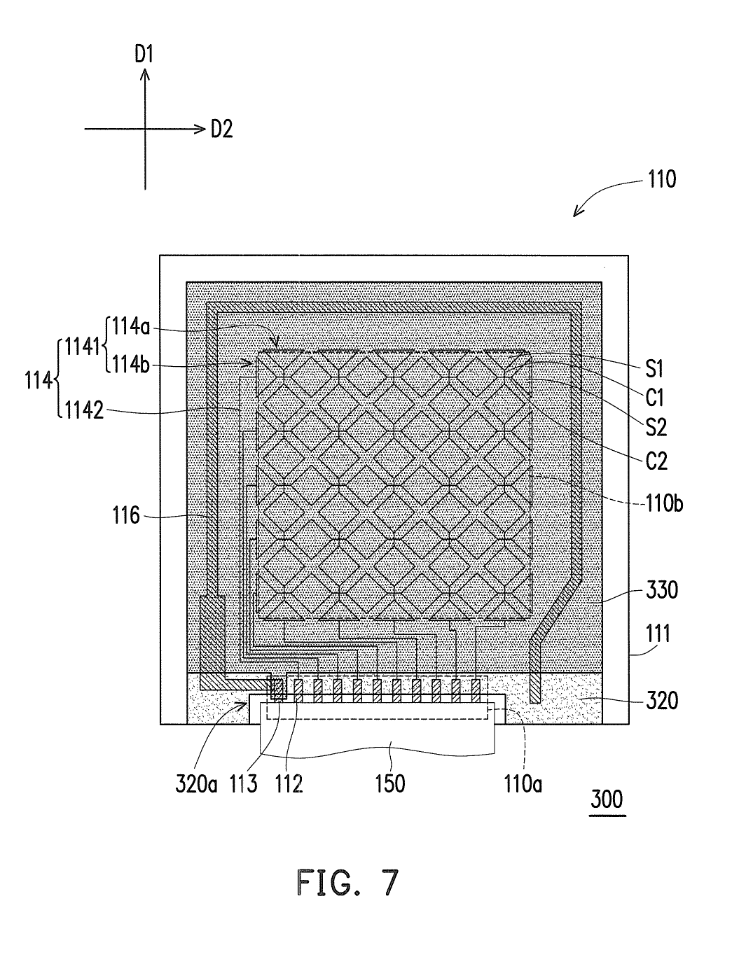

FIG. 7 is a top-view diagram of a touch display device according to another exemplary embodiment of the present invention. As shown in FIG. 7, a portion of the conductive optical adhesive layer 330 of the touch display device 300 extends to the pad area 110a and is directly electrically connected to the ground pad 113. Alternatively speaking, the protection layer 320 of this exemplary embodiment does not include an additional opening for connecting the conductive optical adhesive layer 330 to the ground potential, and the conductive optical adhesive layer 330 is directly electrically connected to the ground pad 113 to connect to the ground potential.

According to the above exemplary embodiments, in the touch display device of the present invention, a conductive optical adhesive layer having a conductive function is configured between the touch-sensing panel and the display panel to provide the shielding effect required by the touch display device. Consequently, the touch display device does not require an additional electromagnetic shield film and the overall thickness of the touch display device can be effectively reduced.

It will be apparent to those skilled in the art that the descriptions above are several preferred embodiments of the present invention only, which does not limit the implementing range of the present invention. Various modifications and variations can be made to the structure of the present invention without departing from the scope or spirit of the invention.

What is claimed is:

1. A touch display device, comprising:
a touch-sensing panel, and the touch-sensing panel comprising a pad area and an active area, and the pad area configured at one side of the active area, the touch-sensing panel comprising:
a substrate;
a plurality of pads disposed on the substrate and at the pad area;
at least one grounding pad, disposed on the substrate and at the pad area;
a touch-sensing device, disposed on the substrate and at least at the active area, and the touch-sensing device comprising a plurality of electrode patterns and a plurality of connecting lines, wherein each of the plurality of connecting lines connects between a corresponding electrode pattern of the plurality of electrode patterns and a corresponding pad of the plurality of pads; and
at least an ESD protection line, disposed on the substrate and at least at a side of the active area, and the ESD protection line connecting to the at least one grounding pad;
a protection layer, covering the touch-sensing panel, and the protection layer comprising a first opening, and the first opening exposing a portion of the pad area;
a conductive optical adhesive layer, disposed on the protection layer, and the conductive optical adhesive layer electrically connecting to the ESD protection line; and
a display panel, wherein the conductive optical adhesive layer is configured between the touch-sensing panel and the display panel.

2. The touch display device as claimed in claim 1, wherein the protection layer comprises a second opening, the second opening exposes a part of the ESD protection line, and the conductive optical adhesive layer is electrically connected to the ESD protection line through the second opening.

3. The touch display device as claimed in claim 1, wherein the protection layer comprises a second opening and the second opening exposes a part of the at least one grounding pad, and the conductive optical adhesive layer is electrically connected to the at least one ground pad through the second opening.

4. The touch display device as claimed in claim 1, wherein the conductive optical adhesive layer comprises an optical adhesive and a plurality of conductive substances distributed in the optical adhesive, and a material of the plurality of conductive substances includes poly ethylene dioxythiophene (PEDOT), polystyrene sulfonic acid (PSS), metal mesh, nano silver or an antistatic agent.

5. The touch display device as claimed in claim 1 further comprising:
a flexible circuit board, wherein a portion of the flexible circuit board is adhered to the pad area, and is electrically connected to the plurality of pads and the at least one grounding pad.

6. The touch display device as claimed in claim 1, wherein an orthogonal projection of the conductive optical adhesive layer on the substrate and an orthogonal projection of the plurality of pads, exposed by the first opening, on the substrate do not overlap.

7. The touch display device as claimed in claim 1, wherein the at least one ESD protection line comprises two ESD protection lines that are respectively disposed at two opposite sides of the active area.

8. The touch display device as claimed in claim 1, wherein the at least one ESD protection line is U shape and located at a peripheral of the active area.

9. The touch display device as claimed in claim 1, wherein a material of the touch-sensing device comprises a transparent conductive material.

10. The touch display device as claimed in claim 1, wherein a material of the at least one ESD protection line comprises metal or a transparent conductive material.

11. The touch display device as claimed in claim 1, wherein the first opening exposes a part of the at least one grounding pad configured at the pad area.
